(19) United States
(12) Patent Application Publication
(10) Pub. No.: US 2004/0226217 A1
(43) Pub. Date: Nov. 18, 2004

(54) Fuel processor for producing hydrogen from hydrocarbon fuels

(75) Inventors: Shabbir Ahmed, Naperville, IL (US); Rajesh K. Ahluwalia, Burr Ridge, IL (US); Sheldon H.D. Lee, Willowbrook, IL (US)

Correspondence Address: FOLEY & LARDNER, 321 NORTH CLARK STREET, SUITE 2800, CHICAGO, IL, 60610-4764, US

(73) Assignee: University of Chicago

(21) Appl. No.: 10/439,744

(22) Filed: May 16, 2003

(51) Int. Cl. B01J 7/00

(52) U.S. Cl. 48/127.9; 48/119; 48/61; 48/62 R

(57) ABSTRACT

A fuel processor having a dynamically controlled thermal integration mechanism and a method for dynamically controlling temperatures in a fuel processor. Such dynamic control accomplished by the use of an autothermal reformer, a steam/air superheater, water/air injectors, water gas shift reactors, heat exchangers, preferential oxidation reactors, wherein the feed/reactant streams are used as the coolant to remove heat from the reformate gas stream.

The United States Government has certain rights in this invention pursuant to Contract No. W-31-109-ENG-38 between the U.S. Department of Energy and The University of Chicago representing Argonne National Laboratories.

### FIELD OF THE INVENTION

The present invention relates to fuel cells that use autothermal reforming. More specifically this invention relates to fuel processor systems having a dynamically controlled thermal integration mechanism that enables the fuel processor to maintain the temperature profile that yields the maximum efficiency and fast transient response during cold starts and during load changes.

### BACKGROUND OF THE INVENTION

Autothermal reforming has been espoused for the conversion of hydrocarbon and alcohol fuels to hydrogen in fuel processors for fuel cell system applications that have constraints on system size and weight, and require rapid start-up and load following capabilities. The idealized form of the autothermal reforming reaction can be written as: CₙHₘOₚ+x(O₂+3.76N₂)+(2n−2x−p)H₂O=nCO₂+(2n−2x−p+m/2)H₂+3.76xN₂ (1) where, x is the oxygen-to-fuel molar ratio. The corresponding oxygen-to-carbon (O/C) and steam-to-carbon (S/C) ratios are represented as 2x/n and (2n−2x−p)/n, respectively. Actual reformers produce significant amounts of carbon monoxide (CO), which requires that the reformer be followed by water gas shift reaction (CO+H₂O=CO₂+H₂) zones and preferential oxidation zones (CO+1/2O₂=CO₂). When the fuel contains sulfur species, all sulfur-containing species must be removed prior to the catalyst that is poisoned by it. This means locating appropriate sulfur traps within the fuel processor.

It has been established that the maximum efficiency of the fuel processor is achievable at the thermoneutral point—the operating point where the oxygen-to-carbon (O/C) and steam-to-carbon (S/C) ratios lead to a zero heat of reaction (ΔHᵣ=0). In the absence of waste heat available from sources outside the fuel processing system, the efficiency, which is defined as the lower heating value of the hydrogen in the reformate as a percentage of the lower heating value of the fuel fed to the fuel processor, of the fuel processor can approach this theoretical limit by using thermal integration. That is by heat exchange between the reactants (being heated) upstream of the reformer, and the products (being cooled) downstream of the reformer. Thermal integration provides the energy needed to generate steam and to preheat the steam and air before they are fed into the reformer. It has been shown that the ability to operate at high preheat temperatures, while at low O/C ratios and achieving high conversions of the fuel to hydrogen and carbon dioxide favors high hydrogen concentrations in the reformate, and thus high fuel processing efficiencies. High S/C ratios favor effective conversion of CO in the shift reactor, and lead to potentially smaller and lighter fuel processors.

Fuel processors for fuel cell systems need to balance many requirements and constraints, the particulars of which are application specific. In general, the fuel processors should be small, lightweight, efficient, capable of rapid start, capable of dynamic response at varying processing rates and inexpensive among other desirable attributes. Fuel processors currently have several constraints and limitations. A fuel processor's efficiency drops at part load. Also, fuel processors are known to be sluggish in responding to step-up transients. Problems arise due to the unavoidable heat losses from the fuel processor and the inability to maintain the reactors at set temperatures at part load, since at reduced flow rates the heat exchangers are oversized. This is particularly true during later shift zones, causing the desired CO conversion to not be achieved.

The fuel processor represents a series of unit operations and processes through which the primary fuel (e.g., hydrocarbon, alcohol, etc.) is converted to a hydrogen-rich gas that is suitable for the fuel cell. The low temperature polymer electrolyte fuel cell usually requires that the hydrogen-rich gas contain less than 10 to 100 parts per million (ppm) carbon monoxide, and there are other tolerance limits known in the art for chemical species such as sulfur and ammonia, as well.

Thus, a fuel processor for applications with constraints discussed above is needed such that it achieves the desired conversion of the feed streams through the shortest path and yet offers the flexibility to accommodate the control algorithms during various steady and transient operating modes such as start-up, steady-state, ramp-up, ramp-down, shutdown, and other various operating modes.

### SUMMARY OF THE INVENTION

Fuel cells, especially those that operate at low temperatures, operate on high purity hydrogen. If a hydrogen supply is unavailable, the fuel cell system includes a fuel processor to convert available hydrocarbon or alcohol fuels into a hydrogen-rich gas that can be used by the fuel cell.

The present invention relates to a novel fuel processor system based on a thermal integration mechanism that enables the fuel processor to maintain the temperature profile that yields the maximum efficiency and dynamic response. With electronic chips determining the “optimal temperature profile” for a given operating load, the thermal integration is continuously adjusted such that the specified “optimal temperature profile” is achieved in the shortest possible time and maintained dynamically as the fuel processing rate varies over time. The present invention further relates to a new process for the conversion of a hydrocarbon fuel into a hydrogen-rich gas, based on autothermal reforming followed by the shift reaction and the preferential oxidation reaction.

### BRIEF DESCRIPTION OF THE DRAWINGS

FIG. 1 is a schematic of an Integrated Fuel Processor with Temperature Control, with Coolant Water Streams in Series;

FIG. 2 is a schematic of water flow through a Thermally Integrated Fuel Processor during Startup;

FIG. 3 is a chart depicting the temperatures along the length of the autothermal reformer after light-off;

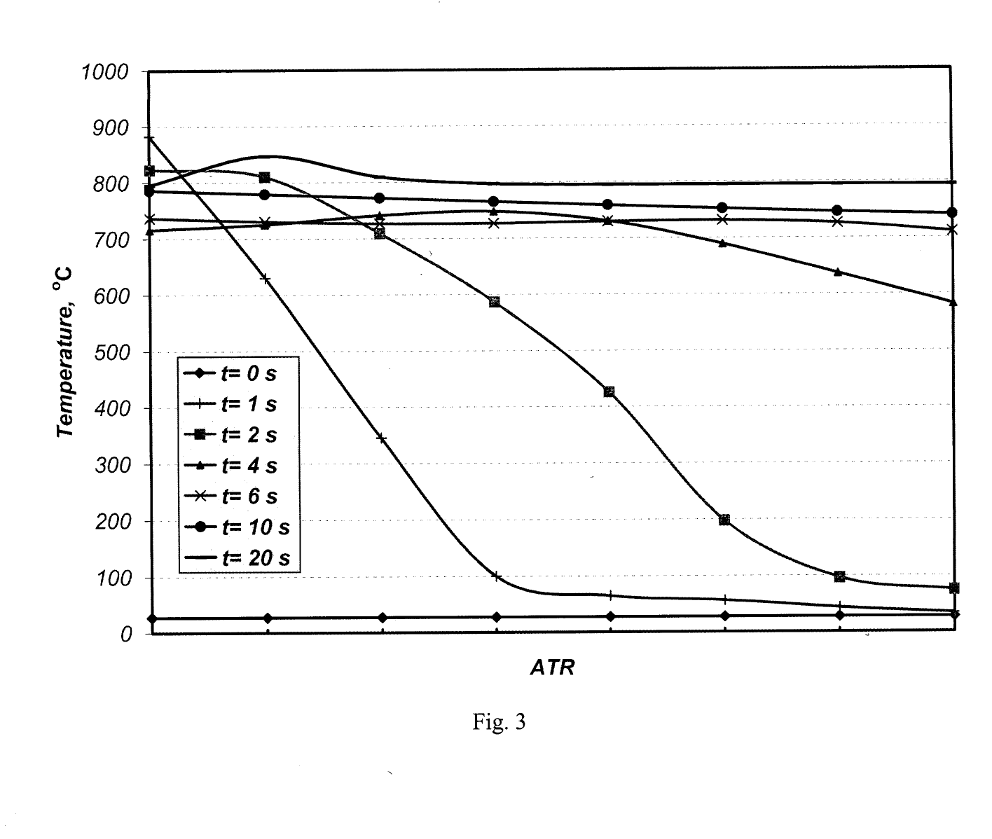

FIG. 4 is a chart of temperatures for Water Gas Shift Reactors 1, 2, 3, and 4 after set time intervals;

FIG. 5 depicts a Thermally Integrated Fuel Processor during reforming operations with the water flowing through all designated flow paths;

FIG. 6 is a chart depicting a Water Gas Shift Reactor and Preferential Oxidation Reactor temperatures and concomitant H₂ and CO concentrations as controlled with intermediate heat exchangers or water quench;

FIG. 7 is a chart depicting Preferential Oxidation Reaction heatup at set intervals of time;

FIG. 8 is a chart of CO Selectivity from Multi Stage Monolith-Supported Preferential Oxidation Reactors;

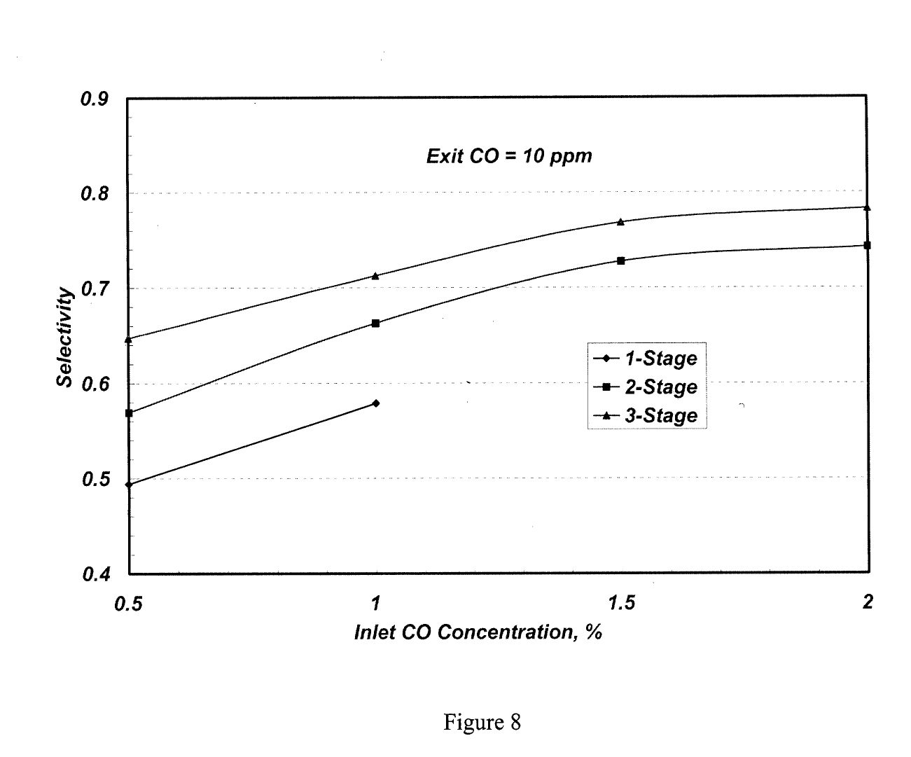

FIG. 9 is a chart depicting Fuel processor production of 75% of rated H₂ after the 30-s startup period; and

FIG. 10 shows a fuel processor that dynamically controls the coolant water flow path and quantity through the heat exchangers.

FIG. 11 is a schematic of an Integrated Fuel Processor with Temperature Control, with Coolant Water Streams in Parallel

### DETAILED DESCRIPTION OF THE INVENTION

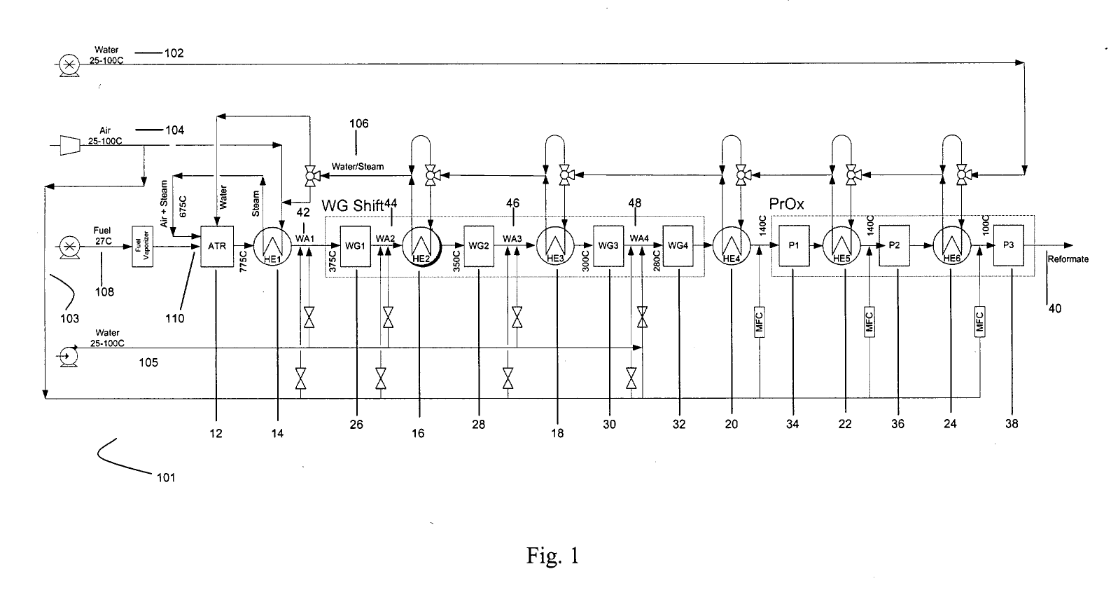

The present invention relates to a new process for the conversion of a hydrocarbon fuel into a hydrogen-rich gas, based on autothermal reforming followed by the shift reaction and the preferential oxidation reaction. As shown in FIG. 1, a preferred embodiment provides a compact (>1000 W/L), inexpensive ($10/kW) and a lightweight (>1000 W/kg) fuel processor 101 with a greater than 80% efficiency based on lower heat value, that is capable of rapid startup (<30 seconds from a cold start) and turn down. The target for transient response is one second for 10% to 90% power. This preferred embodiment consists of an autothermal reformer 12, a heat exchanger 14 which is a steam/air superheater-recuperator, water/air injectors 42, 44, 46, 48, heat exchangers 16, 18, 20, 22, 24, catalytic zones comprising water gas shift reactors 26, 28, 30, 32, and preferential oxidation reactors 34, 36, 38, and balance-of-plant items such as pumps, valves, pipes, sensors and etc. Each of the catalytic zones comprises a separate catalytic stage.

The process includes specifying the desired temperature at several, ideally four to ten, intermediate locations in the reformate flow path and expressly controlling those temperatures. This feature achieves the desired conversion with the least amount of catalyst, which contributes to the compact, lightweight, and inexpensive fuel processor 101 of FIG. 1. With accurate temperature control at these intermediate locations, the fuel processor 101 can maintain desired product quality and high efficiencies at any processing rate within its capacity range as well as during transients. In a preferred embodiment, all of the reformate is cooled by a process water 102 (used in the chemical reactions). The air, which also needs to be preheated, is used as a coolant only in the heat exchanger 14 (also referred to as a recuperator heat exchanger). This is done to reduce the pressure drop and thereby limit the power demand on the air blower/compressor. The present invention may utilize a Fast-Start protocol dependant on bringing the reactors to temperature without having to heat the heat exchangers 14, 16, 18, 20, 22, 24 during the start-up period. For the Fast-Start protocol, the process water 102 bypasses the second through sixth heat exchangers. During Fast-Start, the process water 102 also bypasses the heat exchanger 14 and directly enters the autothermal reformer 12 via a nozzle 110.

The temperatures at these locations are controlled by varying the fraction of coolant 102, for example the process water 102, flowing through the heat exchangers 16, 18, 20, 22, 24. The temperatures at these locations are further controlled by direct injection of liquid, preferably water, into the reformate stream 40. For example, the on-off control function may be accomplished by having the process water 102 bypass the heat exchangers 16, 18, 20, 22, 24 if the reformate temperature is below a set temperature point. Conversely, if the reformate temperature is above a set temperature point, then process water 102 would not bypass the heat exchangers 16, 18, 20, 22, 24 and water quenching could also be utilized by injecting water into the reformate at the water/air injectors 42, 44, 46, 48. The fuel processor 101 may be designed such that the flow path of the coolant 102 through, or bypassing, the heat exchangers 16, 18, 20, 22, 24 and the preferential oxidation reactors 34, 36, 38 is continuously adjusted to maintain a desirable temperature at each of the critical zones (each critical zone is a region where the temperature impacts the efficiency of the fuel processor 101) in a fuel processing train 103. These flow rates also can be continuously adjusted to maintain a desirable temperature at each critical zone in the fuel processing train. In addition, the flow paths can be controlled by 3-way on/off valves. The total process water 102 flow rate can be adjusted with the water pump, while the flow rates through each of the heat exchangers 16, 18, 20, 22, 24 can be adjusted with proportional 3-way valves. The fuel processor 101 can be designed such that the temperature is lowered to the desired value by injecting liquid water through a sparger, such that the endothermic phase change of the injected water leads to cooling of the gas stream. Furthermore, the fuel processor 101 can be designed where the temperature is raised to the desired value by injecting oxygen-containing gas (e.g. air) through a sparger, such that the oxygen reacts with the combustible gases to generate heat. Alternatively, a duty cycle can replace an on-off control system. Thus, it is possible to operate at a steady state with the flow path of process water 102 varying in time.

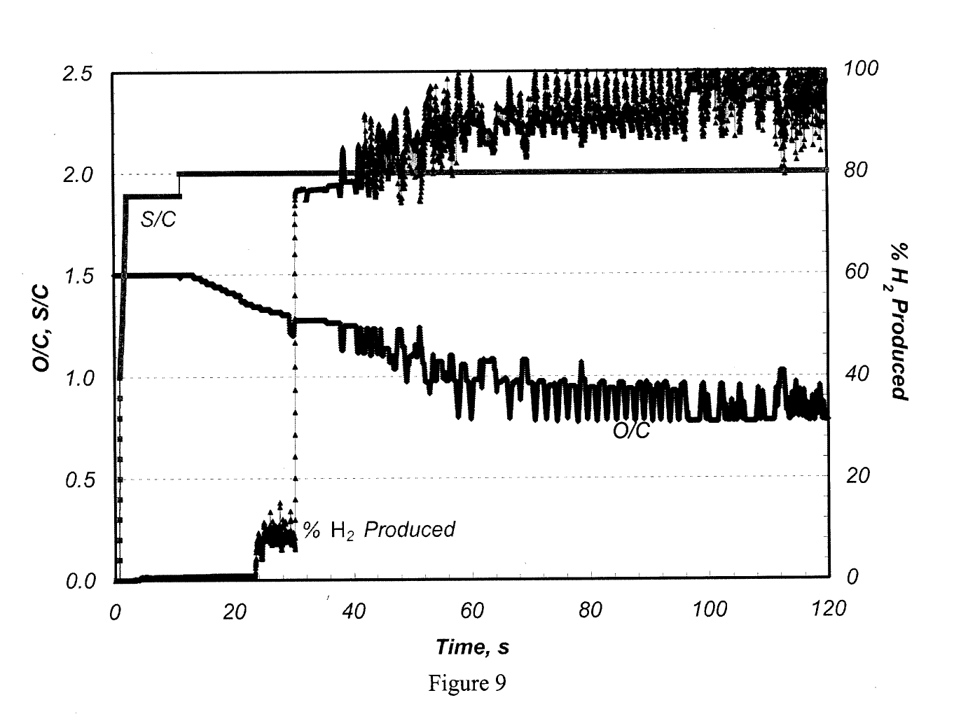

In accordance with the present invention, the fuel processor 101 has been designed that can convert fuels, such as hydrocarbons and alcohols, into a hydrogen-rich gas stream that is suitable for a polymer electrolyte fuel cell. The fuel processor 101 is based on autothermal reforming, because of the many benefits associated with this reaction. Examples of these benefits include: (1) the ability to dynamically control the heat of reaction by varying the O/C ratio; (2) the ability to control the reforming temperature with the O/C ratio and the S/C ratio; (3) when compared to partial oxidation reformers, the ability to operate the autothermal reformer at lower temperatures and being less likely to form carbonaceous deposits; (4) having the fuel processing rate in autothermal reformers not heat transfer limited. The result is a more efficient and faster production of hydrogen. FIG. 9 illustrates the production of hydrogen at set time intervals during start-up.

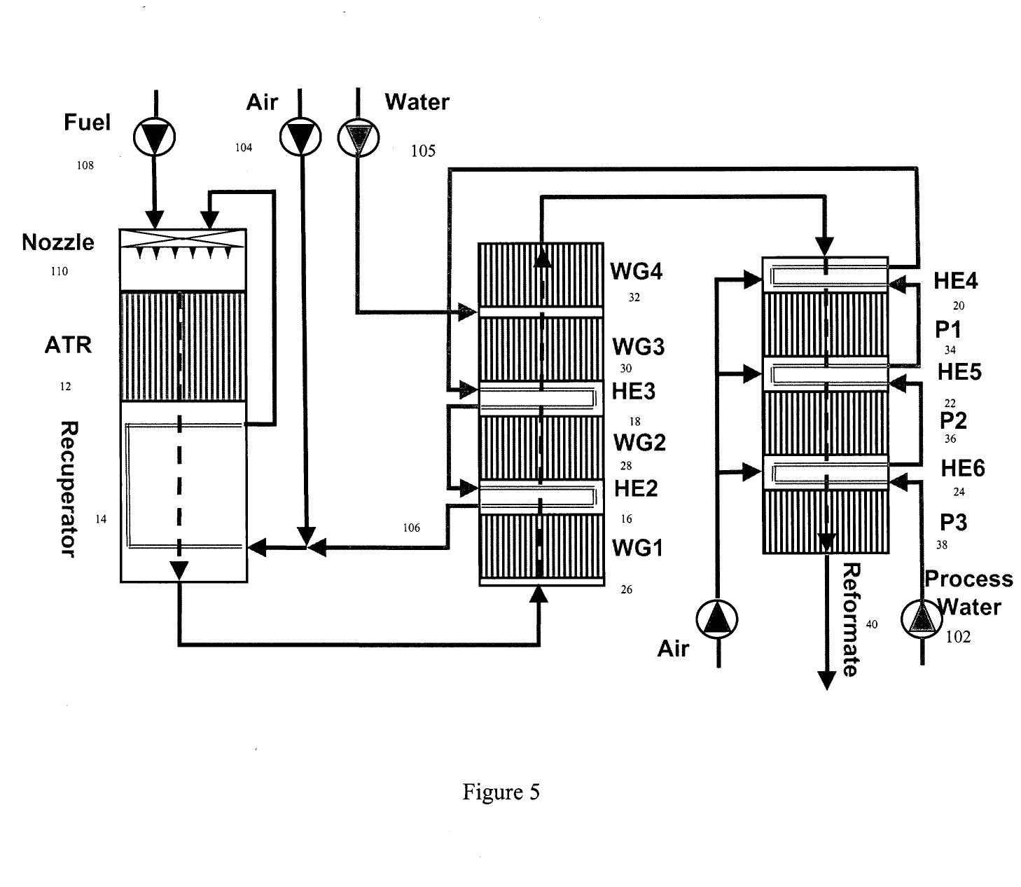

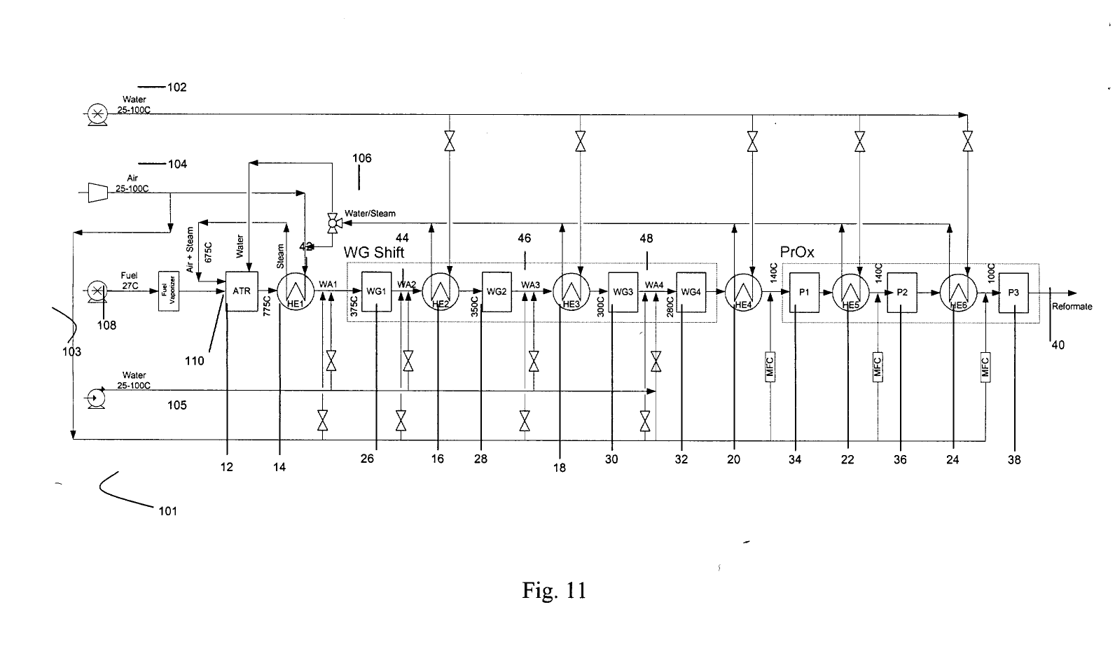

FIG. 1 shows a simplified schematic of the fuel processor 101 reported in the present invention. FIGS. 5 and 11 further illustrate fuel processor systems. The fuel processor 101 of FIG. 1 contains the autothermal reformer 12, the heat exchanger 14, the water/air injector 42, the first water gas shift reactor 26, the water/air injector 44, the heat exchanger 16, the second water gas shift reactor 28, the water/air injector 46, the heat exchanger 18, the third water gas shift reactor 30, the water/air injector 48, the fourth water gas shift reactor 32, the heat exchanger 20, the first preferential oxidation reactor 34, the heat exchanger 22, the second preferential oxidation reactor 36, the heat exchanger 24, and the preferential oxidation reactor 38. In this embodiment of the present invention, the steam and air are preheated to a temperature that approaches the autothermal reformer 12 exit temperature, approximately 775° C. is an optimum temperature for the autothermal reformer 12 for gasoline. This steam and air mixture mixes with the fuel stream in the autothermal reformer 12.

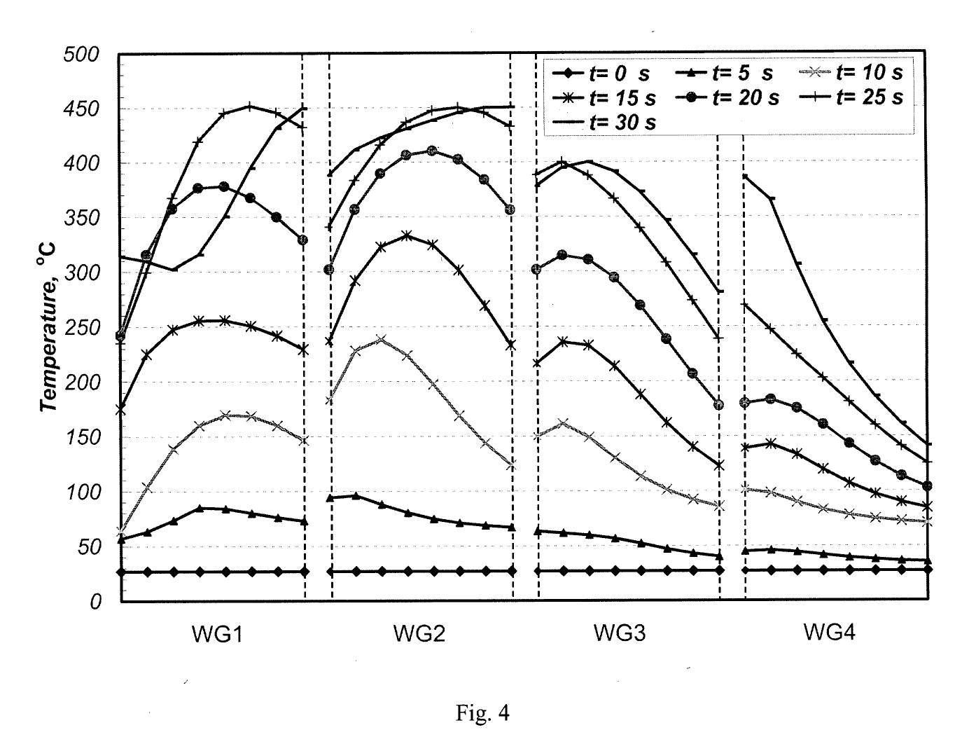

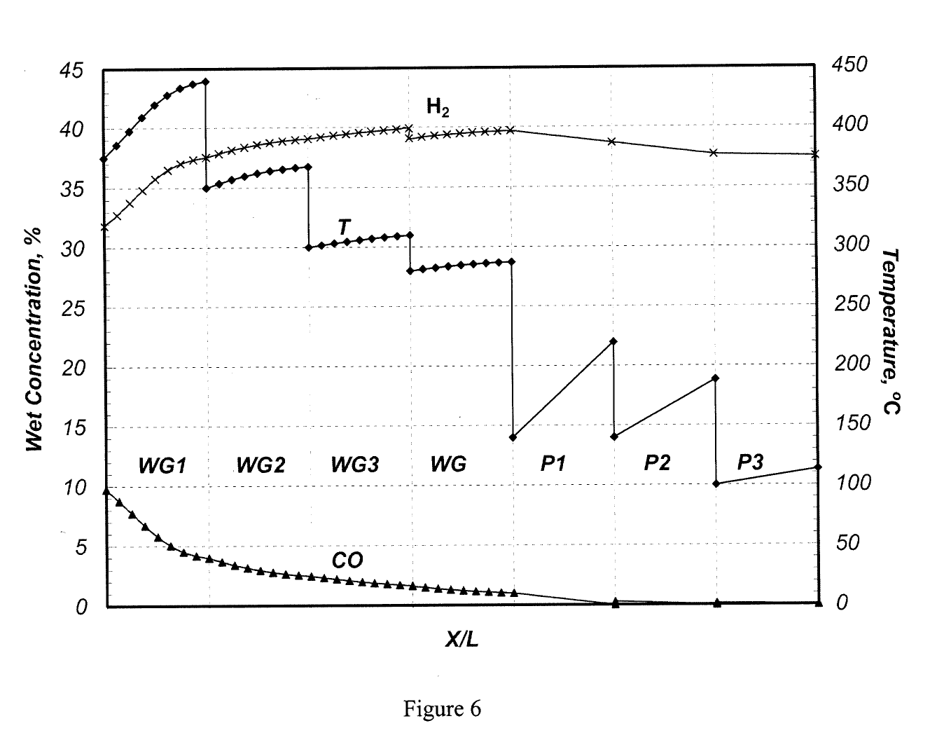

To prevent any pyrolysis or thermal cracking of the fuel components, the fuel stream enters the autothermal reformer 12 at preferably less than 350° C. The reformate from the autothermal reformer 12 is cooled in the heat exchanger 14, for example ideally to 380° C., by the air 104 and water/steam feeds 106 going into the autothermal reformer 12. The reformate temperature at each subsequent catalyst zone inlet is cooler than that of the preceding zone. The reformate then passes through multiple water gas shift reactors 26, 28, 30, 32. FIG. 1 illustrates the fuel processor 101 system with four zones, each containing one of the water gas shift reactors 26, 28, 30, 32 and each separated by one of the heat exchangers 14, 16, 18, and/or one of the water/air injectors 42, 44, 46, 48. FIG. 4 is a chart of the water gas shifts reactors' 26, 28, 30, 32 temperatures during start-up. The heat exchanger 14 can utilize a coolant stream 106 and 104 that is a mixture of air and water. The air and water can be mixed prior to entering the autothermal reformer 12 to provide longer contact time, a larger cooling capacity, greater turbulence to increase heat transfer and lower oxygen concentrations, thus reducing hot spots in the autothermal reformer 12. The temperatures in the fuel processor 101 may be efficiently controlled such that the temperature is lower at each successive critical zone. FIG. 6 is chart depicting the water gas shift reactors' 26, 28, 30, 32 and the preferential oxidation reactors' 34, 36, 38 temperatures as controlled with intermediate heat exchangers or water quench.

Ideally the autothermal reformer 12 is maintained at between 700-950° C., by adjusting the O/C and S/C ratios, and the inlet temperatures of the fuel, air, and steam feeds entering the autothermal reformer 12. Furthermore, the temperatures of the air and steam feeds into the autothermal reformer 12 may be raised to Tₑₓᵢₜ−T_{approach} (temperature at exit minus temperature at approach), where Tₑₓᵢₜ is the reformate gas temperature and T_{approach} is the difference in temperature between the reformate gas as it enters the heat exchanger 14 and the coolant 102 as it exits the heat exchanger 14. The water/air injectors, 42, 44, 46, 48 increase the concentration of steam in the reformate gas and therefore accelerate the kinetics of the water gas shift reaction which results in greater conversion of CO to additional hydrogen. The water added with the water/air injectors 42, 44, 46, 48 raises the effective H₂O/C ratio of the fuel processor 101 to greater than 1.8, preferably in the range 1.8-2.5.

The superheated air/steam mixture coming out of the heat exchanger and flowing into the nozzle at the tip of the reformer 14 is helpful in vaporizing the fuel when the fuel vaporizer is not effective. The heat exchanger 14 may be designed such that T_{approach} is maintained to less than 150 centigrade degrees, and preferably to less than 5 centigrade degrees. The exact approach temperature to be used is to be decided on the basis of optimization between the fuel processor 101 weight, volume, pressure drop, cost, and system efficiency. The average temperature in the autothermal reformer 12 is maintained between 700-950° C., preferably between 750-850° C., by adjusting the O/C ratio of the feeds entering the autothermal reformer 12, which is maintained between 0.5-1.0, preferably between 0.6-0.8. Furthermore, the average temperature in the autothermal reformer 12 is maintained at the desired temperatures by adjusting the H₂O/C ratio of the feeds entering the autothermal reformer 12, which is maintained in the range 1.3-2.5, preferably between 1.5-2.3. The use of an anode gas burner where the combustible gas present in the fuel cell anode effluent is oxidized to generate heat, which energy is then transferred to the autothermal reformer reactant streams, such that the fuel processor 101 can be operated at a higher thermal efficiency.

For optimum efficiency, the catalytic zones 26, 28, 30, 32, 34, 36, 38 preferably operate in a narrow range of temperatures. TABLE 1 describes the target temperature for gasoline in the embodiment of the present invention illustrated in FIG. 1.

TABLE 1
Optimum Temperatures for Catalytic Reactors

| PHASE | ATR | WG1 | WG2 | WG3 | WG4 | P1 | P2 | P3 |
|---|---|---|---|---|---|---|---|---|
| TARGET | 775° C. | 375° C. | 350° C. | 300° C. | 280° C. | 140° C. | 140° C. | 100° C. |
| TEMPERATURE | | | | | | | | |
| OPTIMUM | 700-800° C. | 360-400° C. | 330-370° C. | 280-320° C. | 260-300° C. | 100-150° C. | 100-150° C. | 90-120° C. |
| TEMPERATURE | | | | | | | | |
| RANGE | | | | | | | | |

For highest efficiency, the air 104 and the process water 102 should be preheated as close to the autothermal reformer 12 temperature as possible. Optimum O/C and S/C are determined by the approach temperature, as seen in TABLE 2.

TABLE 2
Approach Temperature's Effect on O/C and S/C

| ATR Temperature | 775° C. | 775° C. | 775° C. | 775° C. |
|---|---|---|---|---|
| Recuperator Approach | 25° C. | 100° C. | 150° C. | 200° C. |
| Temperature | | | | |
| S/C in ATR | 1.7-1.8 | 1.8-1.9 | 1.9-2.0 | 2.0-2.1 |
| O/C in ATR | 0.71 | 0.75 | 0.77 | 0.81 |
| Equilibrium CO at LTS | 0.9% | 0.7% | 0.6% | 0.5% |
| FP Efficiency (%) | 85.2-85.9 | 83.9-84.8 | 83.6-84.5 | 82.9-83.7 |
| Theoretical FP Efficiency | 86.2% | 85.6% | 85.0% | 84.6% |

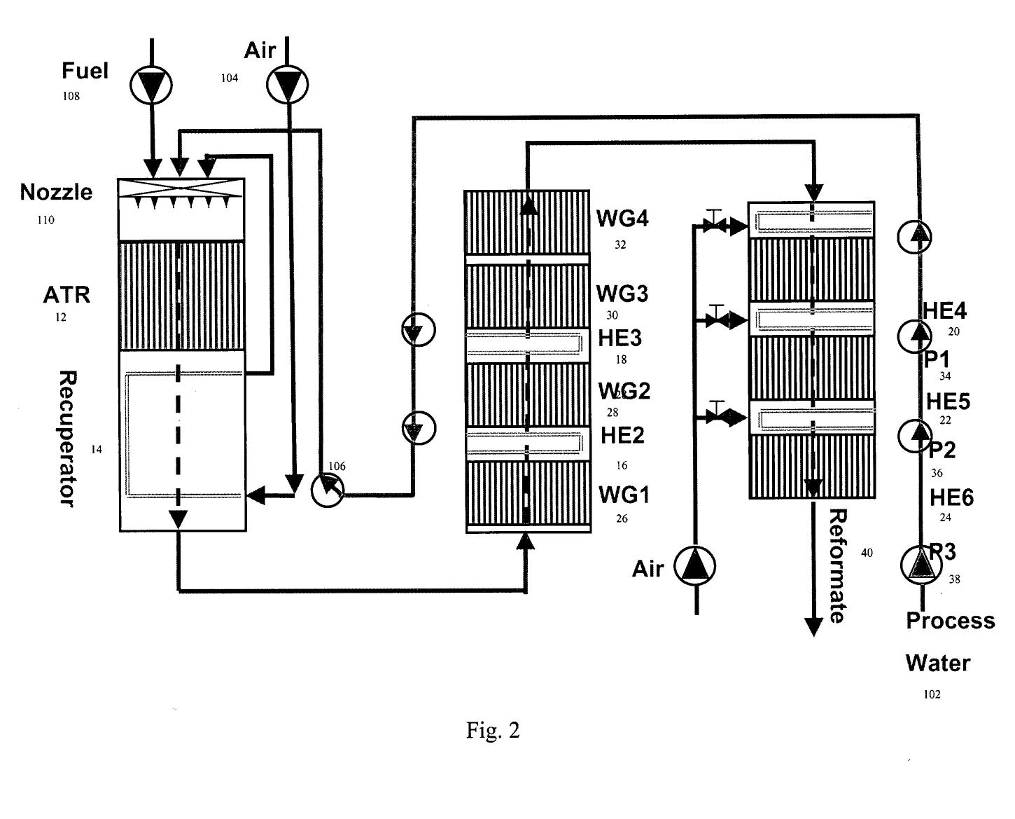

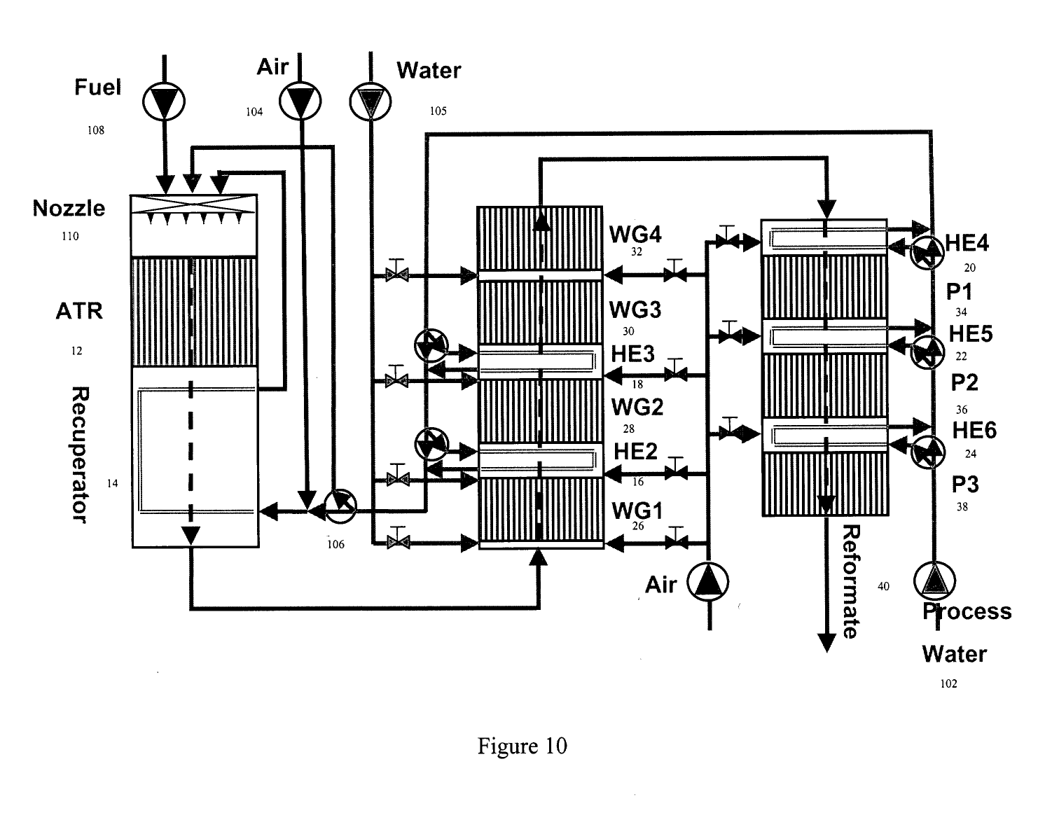

FIG. 2 illustrates the startup mechanism whereby the water 102 and the water/steam 106 feeds bypasses some of the heat exchangers 14, 16, 18, 20, 22, 24. This allows for a substantially increased performance of the fuel processor 101 during first 30 seconds following startup. FIG. 10 is a chart depicting fuel processor production of 75% of rated H₂ after the 30-second startup period. The Fast-Start strategy consists of use of the autothermal reformer 12 for exothermic fuel conversion (partial oxidation reformer, where no water is injected) with O/C>1 to produce hydrogen, carbon monoxide, and other light hydrocarbon gases such as methane, etc. The shift reactors 26, 28, 30, 32 are operated as preferential oxidation reactors by injecting air through the water/air injectors 42, 44, 46, 48. As the autothermal reformer 12, the water gas shift reactors 26, 28, 30, 32 and the preferential oxidation reactors 34, 36, 38 begin to heat up, water is introduced gradually to control the peak temperature. The water gas shift reactors 26, 28, 30, 32 and the preferential oxidation reactors 34, 36, 38 are heated in parallel by distributed combustion of H₂ and CO. In the device depicted by FIG. 1, the heating priority is: first, the water gas shift reactor one 26; second, the water gas shift reactor two 28; third the water gas shift reactor three 30; fourth the preferential oxidation reactor one 34; fifth the preferential oxidation reactor two 36; sixth the preferential oxidation reactor three 38; and seventh the water gas shift reactor four 32. In fact, the water gas shift reactor four 32 need not be brought to operating temperature, nor is it essential to fully heat up the water gas shift reactor three 30. To further facilitate the Fast Start protocol, process water 102 may bypass all of the heat exchangers 14, 16, 18, 20, 22, 24, during start-up. During and immediately after start-up the O/C ratio is >0.75.

The fast start protocol consists of rapidly bringing the autothermal reforming reactor 12 to a design temperature. The autothermal reformer 12 is started as a partial oxidation reactor having an O/C ratio of 1.5. A fuel 108, such as gasoline, is fed to the nozzle 110 as a liquid until the fuel vaporizer is heated above 150° C. Water is introduced gradually to control a peak reactor temperature. Water is also fed together with gasoline until the quality is 1. The O/C ratio is relaxed toward 0.75 after S/C reaches 2.0. Once S/C reaches 2.0, the reactor temperature is controlled by varying O/C.

The water gas shift reactors 26, 28, 30, 32 are started up by heating them in parallel with distributed combustion of H₂ and CO generated by the autothermal reformer 12. Oxidation air is fed to the water gas shift reactors 26, 28, 30, 32, at the water/air injectors 42, 44, 46, 48 in the preferred embodiment illustrated in FIG. 1. If the peak temperature anywhere in a stage exceeds its allowable maximum, the air supply for that stage is cut off. Allowable maximum temperatures for the four stages of the device of FIG. 1 are 450, 450, 400, and 400° C. respectively. The flow path of process water 102 is controlled dynamically. The process water 102 bypasses the heat exchangers 14, 16, 18, 20, 22, 24 unless the gas temperature at the inlet to the catalytic zone following it exceeds its design value. The process water 102 bypasses the heat exchanger 14 until it boils off completely in the remaining heat exchangers.

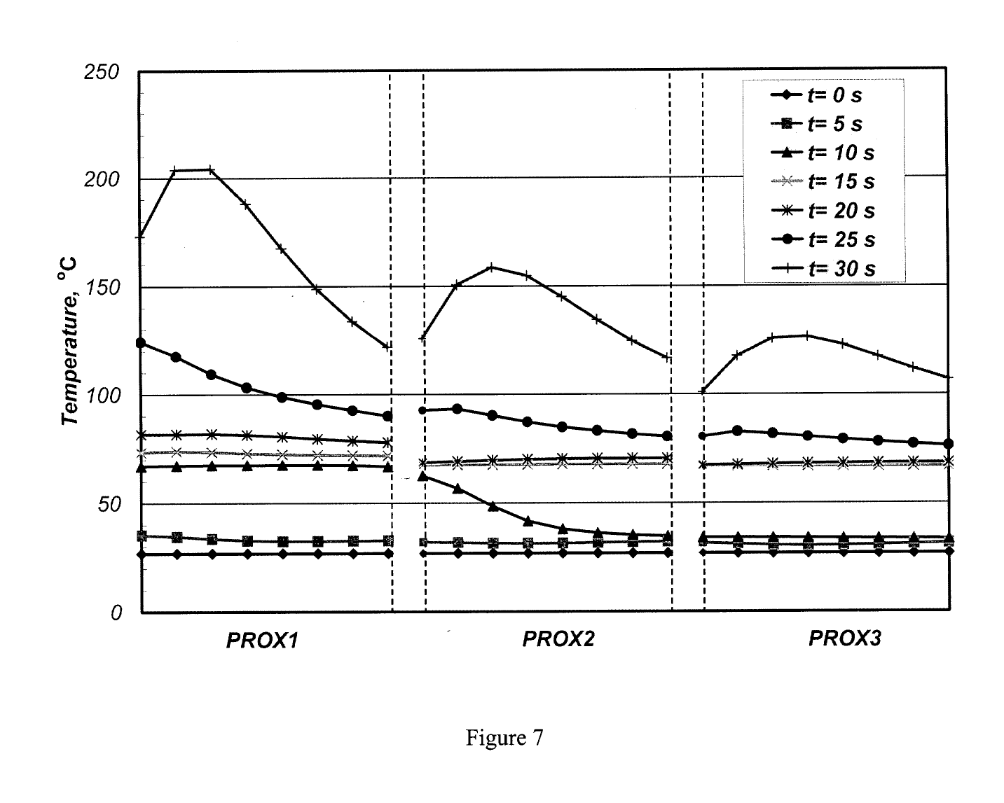

The preferential oxidation reactors 34, 36, 38 are started by bringing them up to temperature using the sensible heat in the reformate leaving the last stage of the water gas shift reactors 26, 28, 30, 32 (i.e. the 4^{th} stage in the preferred embodiment) and by oxidizing the CO present in the reformate gas. If necessary the heatup of the preferential oxidation reactors can be accelerated by injecting additional oxygen to oxidize hydrogen that may be present in the reformate gas The preferential oxidation reactors 34, 36, 38 units include air injectors. FIG. 7 is a chart depicting Preferential Oxidation Reactor heatup at set intervals of time during start-up. Combustion air is fed equally to the stages of the preferential oxidation reactors 34, 36, 38, three in the preferred embodiment. If the peak temperature anywhere in a stage exceeds its allowable maximum, the air supply for that stage is reduced or cut off, and the process water is allowed to flow through the respective upstream heat exchanger to maintain the desired temperature. Allowable maximum temperatures in the preferred embodiment are 250, 225 and 150° C. and FIG. 9 is a chart of Multi Stage Monolith-Supported Preferential Oxidation Reactors.

After the start-up has completed, the system transitions from start-up mode to reforming mode, the supply of combustion air to the water gas shift reactors 26, 28, 30, 32 is terminated. Air feed to the preferential oxidation reactors 34, 36, 38 is determined by the fuel processing rate, the inlet CO concentration and specified stage stoichiometry. Process water 102 bypasses the heat exchanger 14 until it is completely boiled off in the heat exchangers 16, 18, 20, 22, 24. If the reformate temperature at the inlet to the first water gas shift reactor 26 exceeds the set point (375° C. for the example in Table 1), then liquid water must be added at water/air injector 42 to quench the gas mixture down to the set point. The flow path of process water 102 continues to be adjusted dynamically to control the bed temperatures. The S/C ratio is fixed at the specified value (2.0 for the example in Table 2) while O/C is varied to control the autothermal reformer 12 temperature, as represented in TABLE 2.

The heat exchangers 14, 16, 18, 20, 22, 24 are sized to ensure that at the rated operating capacity, the process water 102 cools the reformate stream 40 to the temperature specified for entry into the next catalyst zone 26, 28, 30, 32, 34, 36, 38. At other throughput rates, if the process water 102 flow through the heat exchanger 14, 16, 18, 20, 22, 24 results in excessive cooling, the water flow can be bypassed intermittently to maintain the reformate temperature within a small range around the value specified for that location. If however, the reformate is not cooled to the specified temperature even with the process water 102 flowing through the heat exchangers 14, 16, 18, 20, 22, 24, then liquid water can be injected directly into the reformate stream 40 for evaporative cooling.

There is no heat exchanger before the last shift zone (for example, the fourth water gas shift reactor 32 in the preferred embodiment) and cooling is achieved entirely by liquid water injection. This is because at these relatively lower temperatures (less than 300° C.), it is advantageous to accelerate the kinetic rates for the shift reaction by increasing the concentration of steam in the reformate stream 40. The reformate from the last water gas shift zone then enters the first of the preferential oxidation reactor 34, 36, 38 zones. Before entering each successive of the preferential oxidation reactors 34, 36, 38 zones, the reformate is cooled through the heat exchangers 20, 22, 24.

The nozzle 110 has a dual function. It serves as an atomizer and, for example, in one embodiment it must be capable of atomizing mixture of liquid gasoline and water of between 0-100% gasoline. Gasoline is fed to the nozzle 110 as a liquid until the fuel vaporizer is heated to above 150° C. During the start-up period, water is fed together with gasoline. Further, the nozzle 110 must be able to function as a mixer. During typical reforming mode, the nozzle 110 most preferably should mix gasoline vapor with the mixture of air and superheated steam.

The size of the water gas shift reactors 26, 28, 30, 32 is determined by the S/C and the CO concentrations at inlet and exit (desired), as demonstrated in TABLE 3. It is preferable to minimize the size of the water gas shift reactors 26, 28, 30, 32, while maximizing their efficiency and productivity.

TABLE 3
Size of Water Gas Shift Reactors is Determined by
S/C and Exit CO Concentration

| Approach | 25° C. | | | 100° | | | 150° | | |
|---|---|---|---|---|---|---|---|---|---|
| Outlet CO | 1.2% | 1.1% | 1.0% | 1.1% | 1.0% | 0.9% | 0.9% | 0.8% | 0.7 |
| FP Efficiency | 85.2 | 85.6 | 85.9 | 83.9 | 84.4 | 84.8 | 83.6 | 84.0 | 84.5 |

ATR

| | | | | | | | | | |
|---|---|---|---|---|---|---|---|---|---|
| S/C | 1.75 | 1.70 | 1.66 | 1.94 | 1.89 | 1.83 | 2.01 | 1.95 | 1.89 |
| O/C | 0.71 | 0.71 | 0.71 | 0.75 | 0.75 | 0.75 | 0.77 | 0.77 | 0.77 |

Stage 1

| | | | | | | | | | |
|---|---|---|---|---|---|---|---|---|---|
| Inlet CO | 11.3 | 11.6 | 11.8 | 10.0 | 10.3 | 10.5 | 9.5% | 9.7% | 10.0 |
| H₂O/CO | 1.8 | 1.7 | 1.6 | 2.3 | 2.2 | 2.1 | 2.5 | 2.4 | 2.3 |
| ghsv, (1/h) | 54,00 | 53,49 | 53,00 | 59,67 | 59,05 | 58,44 | 62,45 | 61,74 | 61,08 |

Stage 2

| | | | | | | | | | |
|---|---|---|---|---|---|---|---|---|---|
| Inlet CO | 5.2% | 5.5% | 5.8% | 4.2% | 4.4% | 4.6% | 3.8% | 4.0% | 4.2 |
| H₂O/CO | 2.8 | 2.5 | 2.3 | 4.2 | 3.8 | 3.4 | 4.9 | 4.4 | 4.0 |
| ghsv | 27,86 | 27,60 | 27,35 | 32,31 | 31,98 | 31,65 | 36,02 | 35,63 | 35,24 |

Stage 3

| | | | | | | | | | |
|---|---|---|---|---|---|---|---|---|---|
| Inlet CO | 3.4% | 3.7% | 3.9% | 2.6% | 2.7% | 2.9% | 2.3% | 2.4% | 2.6 |
| H₂O/CO | 3.7 | 3.3 | 2.9 | 6.2 | 5.5 | 4.9 | 7.4 | 6.6 | 5.8 |
| ghsv | 10,34 | 10,30 | 10,20 | 12,15 | 12,02 | 11,90 | 13,65 | 13,34 | 13,30 |

Stage 4

| | | | | | | | | | |
|---|---|---|---|---|---|---|---|---|---|
| Inlet CO | 2.1% | 2.3% | 2.6% | 1.5% | 1.6% | 1.7% | 1.3% | 1.4% | 1.5 |
| H₂O/CO | 7.3 | 6.4 | 5.6 | 12.6 | 11.0 | 9.7 | 15.2 | 13.3 | 11.7 |
| ghsv | 6,230 | 4,170 | 2,450 | 17,81 | 10,00 | 6,310 | 16,47 | 9,410 | 5,720 |
| WGS, kg | 4.6 | 5.8 | 8.2 | 2.9 | 3.5 | 4.4 | 2.8 | 3.5 | 4.6 |

The performance of the preferential oxidation reactors 34, 36, 38 can be optimized, as illustrated by TABLE 4. TABLE 4 is based on Los Alamos National Laboratory data at 100° C. rather than the 140/140/100° C. recommended in this application. The CO selectivity increases with CO concentration. The preferred design as reflected in TABLE 4 is conservative. Two stages may suffice, but with lower selectivity.

TABLE 4
Optimized Performance of Preferential Oxidation Reactor

| Stage | 1 | 2 | 3 | ^{At FP Exit} | Overall |
|---|---|---|---|---|---|
| CO | 1.0% | 0.2% | 0.07% | 10 ppm | |
| Stoichiometry | 1.03 | 1.05 | 2.27 | | 1.40 |
| CO Selectivity | 0.77 | 0.64 | 0.42 | | 0.71 |
| ghsv (1/h) | 37,00 | 37,00 | 37,00 | | 12,300 |

TABLE 5 illustrates the catalyst requirements for a 10 kWe fuel processor designed in accordance with the present invention.

TABLE 5
Catalyst Requirements for a 10 kWe Fuel Processor

| | GHSV (1/h) | Volume | Weight |
|---|---|---|---|
| ATR | 74,000 | 250 | 0.150 |
| WGS | 6308 | 3590 | 2.450 |
| WG1 | 66,000 | 380 | 0.235 |
| WG2 | 41,000 | 570 | 0.375 |
| WG3 | 22,000 | 1040 | 0.690 |
| WG4 | 13,600 | 1600 | 1.150 |
| PrOx | 12,333 | 2130 | 0.870 |
| P1 | 37,000 | 710 | 0.290 |
| P2 | 37,000 | 710 | 0.290 |
| P3 | 37,000 | 710 | 0.290 |
| Totals | 3951 | 5970 | 3.470 |

TABLE 6
Re-optimization of WGS Space Velocities

| | | | | | | |
|---|---|---|---|---|---|---|
| FP Efficiency | 84.4 | 84.4 | 84.4 | 84.4 | 84.4 | 84.4 |
| Stage 4 Inlet | 250° | 250° | 260° | 270° | 280° | 290° |
| Outlet CO Conc. | 1.0% | 1.0% | 1.0% | 1.0% | 1.0% | 1.0% |
| ATR | | | | | | |
| S/C | 1.89 | 1.89 | 1.93 | 1.97 | 2.01 | 2.05 |
| O/C | 0.75 | 0.75 | 0.75 | 0.75 | 0.75 | 0.75 |
| Stage 1 WGS | | | | | | |
| Inlet Co Conc. | 10.3 | 10.3 | 10.1 | 9.9% | 9.7% | 9.5% |
| H2O/CO | 2.2 | 2.2 | 2.3 | 2.4 | 2.5 | 2.5 |
| ghsv, 1/h | 5905 | 6211 | 6340 | 6476 | 6608 | 6734 |
| Stage 2 WGS | | | | | | |
| Inlet Co Conc. | 4.4% | 4.4% | 4.3% | 4.1% | 4.0% | 3.8% |
| H2O/CO | 3.8 | 3.8 | 4.0 | 4.3 | 4.1 | 4.0 |
| ghsv, 1/h | 3198 | 3613 | 3766 | 3923 | 4082 | 4227 |
| Stage 3 WGS | | | | | | |
| Inlet Co Conc. | 2.7% | 2.8% | 2.7% | 2.6% | 2.5% | 2.4% |
| H2O/CO | 5.5 | 5.4 | 5.8 | 6.3 | 6.7 | 7.2 |
| ghsv, 1/h | 1202 | 1387 | 1634 | 1926 | 2230 | 2347 |
| Stage 4 WGS | | | | | | |
| Inlet Co Conc. | 1.6% | 1.7% | 1.6% | 1.6% | 1.6% | 1.5% |
| H2O/CO | 11.0 | 10.6 | 10.8 | 10.8 | 11.0 | 11.3 |
| ghsv, 1/h | 1000 | 9250 | 1130 | 1299 | 1364 | 1206 |
| WGS, kg | 3.5 | 3.4 | 3.0 | 2.6 | 2.5 | 2.6 |

One of the main problems that the present invention overcomes is size, weight, and dynamic response requirements of fuel processors. This is accomplished by enabling precise control of the temperature and temperature profiles at all times, thereby ensuring that the necessary conversions are always achieved within very small catalytic zones. The present invention allows for dynamic control of temperature at critical points. This dynamic temperature control improves the transient response of the fuel processor 101, thus allowing for substantially instantaneous transient response. Dynamic temperature control also allows for a fast start by bringing the reactors to their desired temperatures without having to heat exchangers 14, 16, 18, 20, 22, 24 during start-up. Another benefit of the dynamic temperature control is that the heat exchangers 14, 16, 18, 20, 22, 24 do not need to be precisely sized. This is significant because in many applications the fuel-processing rate is not constant and is rarely at the maximum capacity.

From the foregoing teachings, it can be appreciated by one skilled in the art that a new, novel and nonobvious method and device for the conversion of a hydrocarbon fuel into a hydrogen-rich gas, based on autothermal reforming followed by the shift reaction and the preferential oxidation reaction has been disclosed. It is to be understood that numerous alternatives and equivalents will be apparent to those of ordinary skill in the art, given the teachings herein, such that the present invention is not to be limited by the foregoing description but only by the appended claims.

What is claimed is:

1. A fuel processor comprising a dynamically controlled thermal integration mechanism, wherein the thermal integration mechanism maintains the fuel processor temperature within a predetermined temperatures range.

2. A fuel processor for converting a fuel into a reformate, which is a hydrogen-rich gas, having a reformate temperature, comprising:
a coolant stream having a variably controllable flow path;
an air feed having an air feed temperature;
a water feed having a water feed temperature;
a steam feed having a steam feed temperature;
the reformate having a reformate temperatures, an oxygen to carbon ratio, a steam to carbon ratio;
a fuel processing train having an autothermal reformer, at least one heat exchanger adapted to utilize the coolant stream, at least one water/air injector, at least one water gas shift reactor for controlling the CO and H₂ concentration in the reformate, at least one preferential oxidation reactor and at least one critical zone, and at least one means for dynamically controlling the temperature of the fuel processor; wherein the dynamic control means provides for maintenance of the temperature of the at least one critical zone within a predetermined temperature range.

3. The fuel processor of claim 2, wherein the coolant stream comprises a mixture of air and water to be fed into the autothermal reformer.

4. The fuel processor of claim 2, wherein the reformate temperature at each successive critical zone is lower than in the preceding zone.

5. The fuel processor of claim 2, wherein the temperature of the autothermal reformer is maintained by adjusting the oxygen to carbon ratio, the steam to carbon ratio, and the temperatures of the fuel, air and water feeds entering the autothermal reformer.

6. The fuel processor of claim 2, wherein the controlling means are selected from the group consisting of heat exchangers, liquid injection ports, liquid injection spargers, air injection ports and air injection spargers.

7. The fuel processor of claim 2, wherein the at least one critical zone is located downstream of the reformer in the fuel processing train.

8. The fuel processor of claim 2, having a flow path of the coolant streams that is continuously adjusted to maintain a desirable temperature at each critical zone in the fuel processing train.

9. The fuel processor of claim 2 wherein flow rates of the coolant streams flowing through or bypassing the heat exchangers in the fuel processing train are continuously adjusted to maintain a desirable temperature of the reformate at the at least one critical zone in the fuel processing train.

10. The fuel processor of claim 2, wherein the reformate temperature is lowered to the desired value by injecting liquid water through a sparger, such that the endothermic phase change of the injected water leads to cooling of the gas stream.

11. The fuel processor of claim 2, wherein the reformate temperature is raised to the desired value by injecting oxygen-containing gas through the sparger, such that the oxygen reacts with the combustible gases to generate heat.

12. The fuel processor of claim 2, wherein autothermal reformer temperature is maintained by adjusting the temperatures of the fuel, air, and steam feeds entering the autothermal reformer.

13. The fuel processor of claim 2, wherein the average temperature in the autothermal reformer is maintained by adjusting the steam to carbon ratio and oxygen to carbon ratio of the fuel, air, and steam feeds entering the autothermal reformer.

14. The fuel processor of claim 2, wherein the temperatures of the air and steam feeds into the autothermal reformer are raised to (T_{ATR}_{_{—}}ₑₓᵢₜ−T_{approach}).

15. The fuel processor of claim 2, having an anode gas burner where a combustible gas present in a fuel cell anode effluent is oxidized to generate heat, which energy is then transferred to the autothermal reformer, such that the fuel processor can be operated at a higher thermal efficiency.

16. The fuel processor of claim 2, wherein an electronic chip determines an optimal temperature profile.

17. The fuel processor of claim 2, wherein the at least one water gas shift reactor and the at least one preferential oxidation reactor are heated in parallel by distributed combustion of H₂ and CO.

18. A method of heat exchange between fluids entering and leaving an autothermal reformer comprising the steps of:
mixing air and water feeds prior to entering a heat exchanger;
providing longer contact time between air and water/steam;
providing a greater cooling capacity in the heat exchanger;
providing greater turbulence in the heat exchanger to improve heat transfer; and
lowering the concentration of oxygen in a resulting mixture.

19. The method of claim 18 further comprising the additional step of water bypassing the heat exchanger unless a gas temperature at a stage following it exceeds its design value.

20. The method of claim 18 further comprising the additional step of cutting off air supply for a stage when the temperature for the stage exceeds a predetermined maximum.
